(19) United States
(12) Patent Application Publication
(10) Pub. No.: US 2019/0197581 A1
(43) Pub. Date: Jun. 27, 2019

(54) COMPUTER-IMPLEMENTED METHODS, SYSTEMS COMPRISING COMPUTER-READABLE MEDIA, AND ELECTRONIC DEVICES FOR CURATING DIGITAL CONTENT ACCORDING TO FINANCIAL TRANSACTION RECORDS

(71) Applicant: Mastercard International Incorporated, Purchase, NY (US)

(72) Inventors: Mrutyunjaya Bhattacharjee, Pune (IN); Rajesh Mahalle, Pune (IN); Jerry J. Davis, Wildwood, MO (US)

(73) Assignee: Mastercard International Incorporated, Purchase, NY (US)

(21) Appl. No.: 15/850,899

(22) Filed: Dec. 21, 2017

(51) Int. Cl. G06Q 30/02; G06Q 40/02

(52) U.S. Cl. CPC G06Q 30/0255; G06Q 40/02; G06Q 30/0243; G06Q 30/0267

(57) ABSTRACT

A computer-implemented method for serving digital assets curated according to financial transaction records that includes receiving a unique user identification corresponding to a user, and retrieving a plurality of financial transaction records associated with the user. The plurality of financial transaction records may be evaluated against criteria for a plurality of content segments, and the user maybe classified in at least one of the plurality of content segments based at least in part on the evaluation of the plurality of financial transaction records. At least one digital asset may be served to the user at a user device based on the classification.

### FIELD OF THE INVENTION

The present disclosure generally relates to computer-implemented methods, systems comprising computer-readable media, and electronic devices for curating digital content according to financial transaction records.

### BACKGROUND

Existing ad servers obtain data regarding browsing users that relates to, for example, demographic characteristics and interests, and submit that data to relevance algorithms to determine one or more advertisement(s) that are most relevant to the browsing users. Existing relevance algorithms generally infer relevance of one or more available advertisements by relying on a broad array of essentially unprotected data and drawing inferences about the browsing users based on such data.

This background discussion is intended to provide information related to the present invention which is not necessarily prior art.

### BRIEF SUMMARY

Embodiments of the present technology relate to computer-implemented methods, systems comprising computer-readable media, and electronic devices for curating digital content according to financial transaction records. The embodiments may provide enhanced targeting of digital assets to relevant users.

More particularly, in a first aspect, a computer-implemented method for serving digital assets curated according to financial transaction records may be provided. The method may include receiving a unique user identification corresponding to a user, and retrieving a plurality of financial transaction records associated with the user. The plurality of financial transaction records may be evaluated against criteria for a plurality of content segments, and the user maybe classified in at least one of the plurality of content segments based at least in part on the evaluation of the plurality of financial transaction records. At least one digital asset may be served to the user at a user device based on the classification. The method may include additional, less, or alternate actions, including those discussed elsewhere herein.

In another aspect, a computing device for serving digital assets curated according to financial transaction records may be provided. The computing device may include a communication element, a memory element and a processing element. The communication element may be configured to provide electronic communication with a communication network. The processing element may be electronically coupled to the memory element and to the communication element. The processing element may be configured to execute a content segment framework application configured to: receive a unique user identification corresponding to a user; retrieve a plurality of financial transaction records associated with the user; evaluate the plurality of financial transaction records against criteria for a plurality of content segments; and classify the user in at least one of the plurality of content segments based at least in part on the evaluation of the plurality of financial transaction records. At least one digital asset may be served to the user at a user device based on the classification. The system may include additional, less, or alternate functionality, including that discussed elsewhere herein.

In still another aspect, a system comprising computer-readable media for serving digital assets curated according to financial transaction records may be provided. The system may include a non-transitory computer-readable medium with a program stored thereon, wherein the program instructs a hardware processing element of a device to: receive a unique user identification corresponding to a user; retrieve a plurality of financial transaction records associated with the user; evaluate the plurality of financial transaction records against criteria for a plurality of content segments; and classify the user in at least one of the plurality of content segments based at least in part on the evaluation of the plurality of financial transaction records. At least one digital asset may be served to the user at a user device based on the classification. The program(s) stored on the computer-readable media may instruct the processing elements to perform additional, fewer, or alternative actions, including those discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 illustrates various components, in block schematic form, of an exemplary system for curating digital content according to financial transaction records in accordance with embodiments of the present invention;

FIGS. 2 and 3 illustrate various components of exemplary servers shown in block schematic form that may be used with the system of FIG. 1;

FIG. 4 illustrates various components of an exemplary content management computing device shown in block schematic form that may be used with the system of FIG. 1;

FIG. 5 illustrates various components of exemplary user electronic devices shown in block schematic form that may be used with the system of FIG. 1;

FIG. 6 is a flowchart of various components of exemplary systems for curating digital content according to financial transaction records, and of relationships between the components, in accordance with embodiments of the present invention; and

FIG. 7 illustrates at least a portion of the steps of an exemplary computer-implemented method for curating digital content according to financial transaction records in accordance with an embodiment of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Digital asset management software packages generally provide tools for curating webpages and for centralized indexing and enhanced retrievability of digital assets for use across multiple pages and applications. A typical digital asset management software package may provide one or more templates or other tools to help a curator specify and position components while building a webpage. The digital asset management package may be configured to make metadata tags available for application to digital assets, the tags being related to the content of the digital asset and/or the consumer(s) most likely to have a desire to encounter the digital asset. For instance, an image asset may show a skier traversing a snowy mountain, and a metadata tag may be applied that reads “winter vacation.” The tagged asset may be indexed and retrieved according to the tag when the digital asset management software is employed for selection of digital assets to populate a webpage. Exemplary digital asset management software that may be used with embodiments of the present invention is made available, as of the priority date of this disclosure, by Adobe Systems Incorporated under the mark Adobe Experience Manager™, which includes content, tag and commerce modules referenced below.

The present embodiments may relate to, inter alia, systems, devices and methods for curating digital content according to financial transaction records that provide enhanced targeting of digital assets to relevant users. In an embodiment, financial transaction records are evaluated against pre-defined rules for evaluating structured financial transaction data. The rules may define a plurality of independent (though not necessarily mutually exclusive) content segments, delineated in view specifically of structured financial transaction record data. The financial transaction data of a user may be automatically processed upon identification (e.g., login or other form of authentication) to assign the user to one or more of the content segments. Each of the plurality of content segments may also be associated with one or more digital assets (e.g., using tags, folder groupings, direct assignments, etc.) within a novel taxonomic framework. In this manner, improved delivery of digital assets based on financial transaction records may be realized.

Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

### Exemplary System

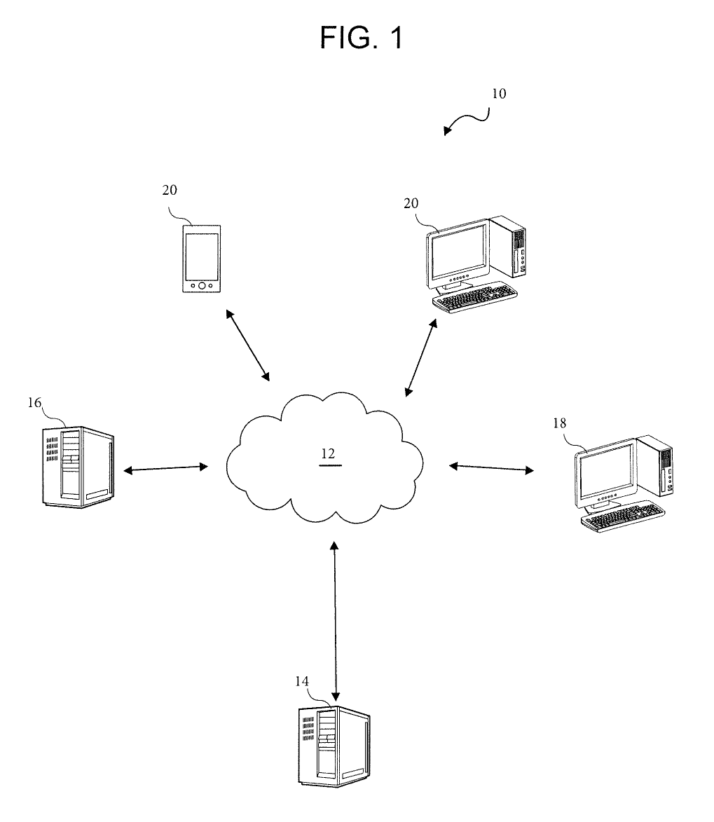

FIG. 1 depicts an exemplary environment in which embodiments of a system 10 may be utilized for curating digital content according to financial transaction records. The environment may include a communication network 12 for enabling communications between components of the system 10. The system 10 may also include a financial records server 14; a storage server 16; and a content management computing device 18 operated by a curator. The system may further include user electronic devices 20. Each user electronic device 20 may execute a browser 22 and an operating system 24, financial records server 14 may execute a transaction record API 26, and storage server 16 may execute a digital content platform application 28.

Broadly, the communication network 12 may allow communication between the user electronic devices 20, the content management computing device 18, and the servers 14, 16. The communication network 12 may include local area networks, metro area networks, wide area networks, cloud networks, the Internet, cellular networks, plain old telephone service (POTS) networks, and the like, or combinations thereof. The communication network 12 may be wired, wireless, or combinations thereof and may include components such as modems, gateways, switches, routers, hubs, access points, repeaters, towers, and the like. For example, the user electronic devices 20 may generally connect to the communication network 12 wirelessly, such as by radio frequency (RF) communication using wireless standards such as cellular 2G, 3G, 4G, or 5G, Institute of Electrical and Electronics Engineers (IEEE) 802.11 standards such as WiFi, IEEE 802.16 standards such as WiMAX, Bluetooth®, or combinations thereof.

Each server 14, 16 generally retains electronic data and may respond to requests to retrieve data as well as to store data. The servers 14, 16 may be embodied by application servers, database servers, file servers, gaming servers, mail servers, print servers, web servers, or the like, or combinations thereof. Furthermore, the servers 14, 16 may include a plurality of servers, virtual servers, or combinations thereof. The servers 14, 16 may be configured to include or execute software such as file storage applications, database applications, email or messaging applications, web server applications, or the like, in addition to and/or in conjunction with software applications 26, 28.

In an embodiment, the storage server 16 may include a front-end server, a digital content server, a network interface, and various databases including a digital content database and a publisher account database (not shown). Other conventional features, such as firewalls, load balancers, application servers, failover servers, site management tools, and so forth may also be utilized in conjunction with the storage server 16 but are not shown. The servers 14, 16 may apply business methods or algorithms, may utilize lookup tables or databases, receive user input via one or more peripheral devices or associated systems, or perform tasks in connection with the steps outlined herein.

The servers 14, 16 may respectively include communication elements 30, 32, processing elements 34, 36, and memory elements 38, 40.

The communication elements 30, 32 generally allow communication with external systems or devices. The communication elements 30, 32 may include signal or data transmitting and receiving circuits, such as antennas, amplifiers, filters, mixers, oscillators, digital signal processors (DSPs), and the like. The communication elements 30, 32 may establish communication wirelessly by utilizing RF signals and/or data that comply with communication standards such as cellular 2G, 3G, 4G, or 5G, IEEE 802.11 standard such as WiFi, IEEE 802.16 standard such as WiMAX, Bluetooth™, or combinations thereof. Alternatively, or in addition, the communication elements 30, 32 may establish communication through connectors or couplers that receive metal conductor wires or cables which are compatible with networking technologies such as ethernet. In certain embodiments, the communication elements 30, 32 may also couple with optical fiber cables. The communication elements 30, 32 may be in communication with or electronically coupled to memory elements 38, 40 and/or processing elements 34, 36.

Preferably the devices of the system 10 communicate via secure and/or encrypted communication means. For example, all or some of the servers 14, 16, the mobile electronic devices 20, and the content management computing device 18 may utilize Mutual Secure Sockets Layer (MSSL) technology for authenticating and exchanging transmissions. Communications between the content management computing device 18 and the financial records server 14 are preferably exchanged under such secure protocol(s), particularly in embodiments where personal financial data is included in such communications. It is foreseen that any means for secure exchange may be utilized without departing from the spirit of the present invention.

The memory elements 38, 40 may include data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, USB ports, or the like, or combinations thereof. The memory elements 38, 40 may include, or may constitute, a “computer-readable medium.” The memory elements 38, 40 may store the instructions, code, code segments, software, firmware, programs, applications, apps, services, daemons, or the like that are executed by the processing elements 34, 36. The memory elements 38, 40 may also store settings, data, documents, sound files, photographs, movies, images, databases, and the like.

The processing elements 34, 36 may include processors, microprocessors, microcontrollers, DSPs, field-programmable gate arrays (FPGAs), analog and/or digital application-specific integrated circuits (ASICs), or the like, or combinations thereof. The processing elements 34, 36 may generally execute, process, or run instructions, code, code segments, software, firmware, programs, applications, apps, processes, services, daemons, or the like. The processing elements 34, 36 may also include hardware components, such as finite-state machines, sequential and combinational logic, and other electronic circuits that may perform the functions necessary for the operation of embodiments of the current inventive concept. The processing elements 34, 36 may be in communication with the other electronic components through serial or parallel links that include address busses, data busses, control lines, and the like.

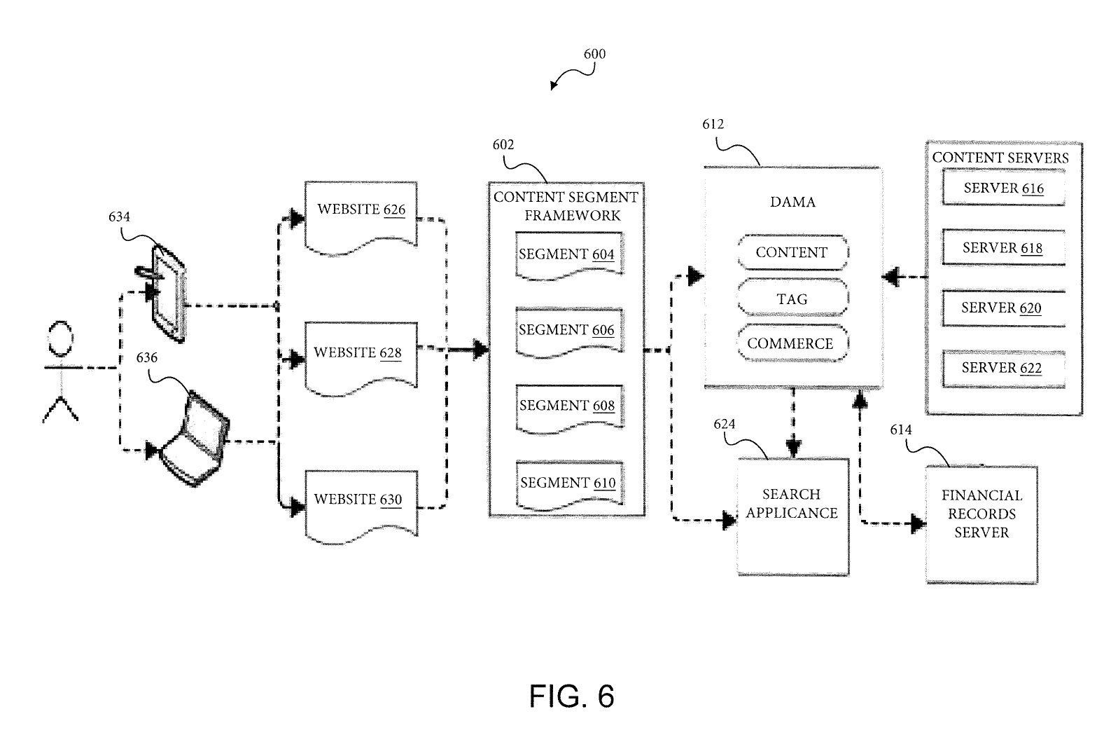

A user electronic device 20 or content management computing device 18 may be embodied by a smart watch, a smart phone, a personal digital assistant (PDA), a tablet, a palmtop or laptop computer, a desktop computer, a notebook, a netbook, smart glasses, wearable and non-wearable electronics (e.g., any IoT device), or other electronic device having computing capacity. A user electronic device 20 may include a GPS receiver element 44, a memory element 48, a processing element 52, software applications 22, 24 and/or a communications element 56, as seen in FIG. 5. The memory element 48 may store the software applications 22, 24, and the processing element 52 may execute the software applications 22, 24. The content management computing device 18 may include a memory element 58, a processing element 60, a communications element 62, a digital asset management application (“DAMA”) 64 and/or a records assimilation module 66, as seen in FIG. 4. The memory element 58 may store the software applications 64, 66, and the processing element 60 may execute the software applications 64, 66. The content management computing device 18 may also or alternatively include a web server (e.g., see FIG. 6). The web server may include a front-end server, a digital content server, a network interface, and various databases including a digital content database. Other conventional features, such as firewalls, load balancers, application servers, failover servers, site management tools (such as DAMA 64), and so forth may also be utilized in conjunction with the web server but are not shown.

The majority of components of each user electronic device 20 or content management computing device 18—more specifically, the communications elements 56, 62, processing elements 52, 60, and memory elements 48, 58—may operate and be constructed according to similar principles and with similar components to those set forth above with respect to analogous components of the servers 14, 16. GPS receivers 44 may operate according to known principles for GPS receivers and/or chips common to smartphones, for example.

Turning now to FIG. 6, a block schematic diagram is provided illustrating components of an exemplary system 600 for curating digital content according to financial transaction records. The exemplary block diagram 600 illustrates an embodiment having a content segment framework application 602 defining content segments 604, 606, 608, 610; a DAMA application 612 that includes customary content, tag and commerce modules for classifying, indexing and organizing digital assets for automated selection in connection with rendering content for websites; a financial records server application 614; a plurality of content server applications 616, 618, 620, 622; and a search appliance 624. The system 600 further includes a plurality of websites 626, 628, 630; and user devices 634, 636. “Digital assets” may include audio files, video files, image files, and the like.

Referring also to the system 10 of FIG. 1, the content segment framework application 602 may reside on the content management computing device 18 and may comprise and/or work in conjunction with records assimilation module 66. The DAMA application 612 and search appliance 624 may reside on the content management computing device 18 and may comprise and/or work in conjunction with DAMA 64. An exemplary search appliance for use in embodiments of the invention may be made available under the mark Google® Search Appliance as of the priority date of this disclosure. Further, the financial records server application 614 may reside on the financial records server 14 and may comprise and/or work in conjunction with the transaction record API 26. Still further, the content server applications 616, 618, 620, 622 may reside on the storage server 16 and may comprise and/or work in conjunction with the digital content platform application 28. The digital content platform application 28 may comprise a database management system managing access to and storage of digital assets within the aforementioned databases and platforms. The plurality of websites 626, 628, 630 may be hosted by the content management computing device 18 and/or an associated web server. The user devices 634, 636 may be embodied by user electronic devices 20.

It is foreseen that the aforementioned applications and/or databases and/or their functions described herein may be distributed for execution across various computing devices of a system, and may be co-located on a single device in some cases, without departing from the spirit of the present invention. Moreover, it is foreseen that one or more of the software applications discussed herein may access data of one or more databases with and/or through one or more database management systems, as is commonly known, without departing from the spirit of the present invention.

### Exemplary Computer-Implemented Method

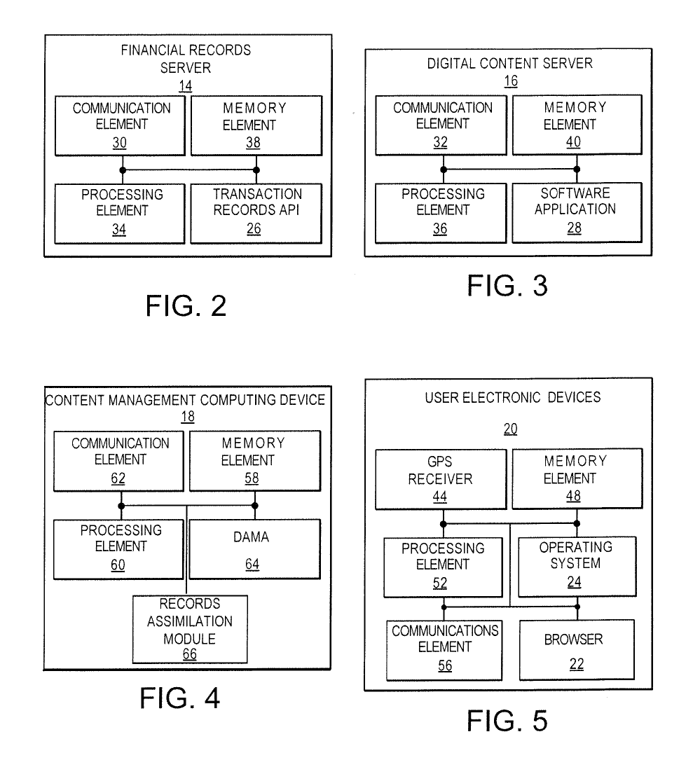

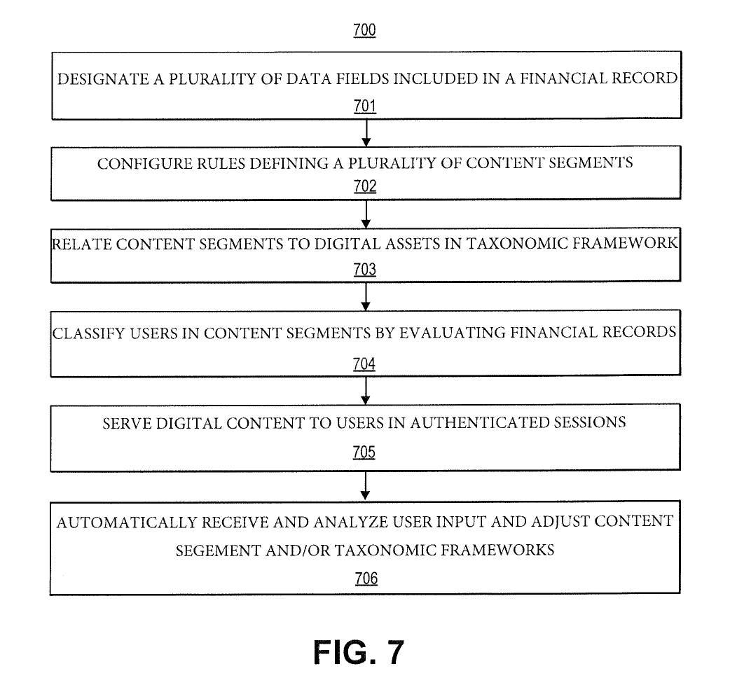

FIG. 7 depicts a listing of steps of an exemplary computer-implemented method 700 for curating digital content according to financial transaction records. Some steps may be performed concurrently as opposed to sequentially, and may in some cases be performed in a different order. In addition, some steps may be optional. The computer-implemented method 700 is described below, for ease of reference, as being executed by exemplary devices and components introduced with the embodiments illustrated in FIGS. 1-6. For example, the steps of the computer-implemented method 700 may be performed by an electronic device 20, content management computing device 18, the servers 14, 16, and the network 12 through the utilization of processors, transceivers, hardware, software (such as the software applications 22, 24, 26, 28, 64 and/or 66), firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs, such as a content segment framework application and a digital asset management application (which may comprise one or more module(s) of the same application), stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

The International Organization for Standardization (ISO) specifies certain data for exchange in financial transactions. For example, ISO 8583 specifies message structure, format and content, data elements and values for data elements comprising a common interface by which financial transaction card-originated messages can be interchanged. While certain transaction data elements may be considered optional and others required under common implementations of ISO 8583, depending on the processing entity(ies) and/or regions in question for example, such variances are well understood by a person of ordinary skill. In this regard, the following generally known standards for completing financial transactions are hereby incorporated by reference: ISO 8583 Part 1: Messages, data elements and code values (2003); ISO 8583 Part 2: Application and registration procedures for Institution Identification Codes (IIC) (1998); and ISO 8583 Part 3: Maintenance procedures for messages, data elements and code values (2003)). The fields defined by ISO standards (e.g., 8583 and 18245) may include: primary account number (Field 2); transaction type (Field 3); amount transaction (Field 4); transmission date and time (Field 7); retrieval reference number (Field 37); response code (Field 39); card acceptor name/location (Field 43); personal identification number (Field 52); and merchant type (Field 18).

One of ordinary skill would immediately understand that the format and content of the aforementioned data elements and fields may vary, and that they and the parameters and metadata outlined herein are merely exemplary. For example, exemplary data elements of embodiments of the present invention may be included in one or more existing fields provided for under the ISO 8583 standard, and/or may be given meaning according to one or more message type indicators and/or bitmaps in a manner analogous to common practice under the ISO 8583 standard. However, exemplary data elements of embodiments of the present invention may be otherwise obtained, stored and utilized in the framework(s) discussed herein, for example under different mapping and message header protocols, without departing from the spirit of the present invention. The transaction record data may also be obtained and managed by the transaction records API 26 at the financial records server 14 in conjunction with user sign up, intake and/or account management processes without departing from the spirit of the present invention. It should also be noted that, in an embodiment, access to and/or use of a user's financial transaction records in the manner outlined herein may be predicated on the user's express consent therefor, for example as indicated by a threshold data field in the user's profile stored by the financial records server 614.

Referring to step 701 and the exemplary components of FIG. 6, the curator may select a plurality of data fields stored in a database managed by the financial records server application 614. For example, the curator may select Fields 2, 3, 4, 7, 18, 39, 43 and 52 (as discussed above) along with a rewards program designation stored in a user profile managed by the financial records server application 614. A rewards program designation may be a unique alphanumeric identifier assigned by the financial records server application 614 that reflects a rewards program the user is currently participating in. It is foreseen that a variety of data fields may be selected by the user for inclusion in one or more content segments 604, 606, 608, 610 without departing from the spirit of the present invention. One of ordinary skill will immediately recognize that the selection(s) may be performed via the DAMA application 612 within the ambit of the present invention.

Referring to step 702, the curator may configure one or more pre-defined rules incorporating the plurality of data fields to define content segment 604. In an embodiment, the pre-defined rules defining the content segment 604 may comprise one or more logical, algorithmic, quantitative and/or mathematical standards for evaluating the user data in the plurality of selected data fields to determine whether and/or to what extent the user satisfies the criteria for inclusion in the content segment 604. In a simple example, the following combination of rules or pre-defined elements may define the criteria for including a particular user in the content segment 604: (A) the user must have charged at least $10,000 on his/her credit card within the preceding month (Fields 2, 3, 4 and 7); (B) the user must not have had a charge transaction request declined within the preceding month (Fields 2, 3, 7 and 39); and (C) the user must be enrolled in a particular awards program according to a data field of the user profile record(s) managed by the financial records server application 614.

In another example, a factor test may be used to define a content segment 606. For instance, a weighted summation of several of the values of the plurality of data fields may be configured to define the content segment 606. An exemplary weighted summation—formatted as a logical argument—may place a user within content segment 606 if the following expression is true: A+B>10,000 (where A=total charges in preceding month and B=the number of unique transactions using a credit card in the preceding month times a factor of two hundred (200) (Fields 2, 3, 4, 7, 37 and 39)).

In yet another example, the content segment 608 may be defined by a required element and a factor-based rule. Inclusion in the content segment 608 may require a user to not be presently enrolled in a rewards program according to a data field of the user profile record(s) managed by the financial records server application 614. In addition, the user must satisfy the following: A+B>10,000 (where A and B are as defined above).

In yet still another example, the content segment 610 may be defined by a number of independent queries. For instance, as a threshold inquiry, the user must not be presently enrolled in a rewards program according to a data field of the user profile record(s) managed by the financial records server application 614. In addition, the user must have made at least fifteen (15) purchases on a credit card having one of the following merchant type codes within the last month (Fields 2, 3, 7 and 18): 5655, 5947, 7032 or 7941 (see ISO code definitions relating to sports).

One of ordinary skill will immediately appreciate from the description above that many types and combinations of logical, algorithmic, quantitative and/or mathematical standards or rules may be generated for use in defining content segments within the ambit of the present invention. One of ordinary skill will also appreciate that such content segments may be mutually exclusive and/or overlapping within the ambit of the present invention. It is foreseen that any number of content segments may be established and defined based on financial transaction record data fields without departing from the spirit of the present invention. Moreover, it is foreseen that content segments may be defined in groups without departing from the spirit of the present invention. For example, certain content segments may only be satisfied by users having a particular bank identification number (BIN), in which case satisfaction of those segments' rules may be evaluated once as a threshold matter rather than repeatedly for each content segment of the group.

Referring to step 703, the curator may establish a taxonomic framework for relating digital assets to content segments 604, 606, 608, 610. The curator may use tools available via the DAMA application 612 and/or search appliance 624 to construct the taxonomic framework without departing from the spirit of the present invention. For example, the curator may specify one or more digital assets for potential display to users satisfying the pre-defined rules for segments 604 and 606, such as where the curator is interested in targeting high net worth and/or loyal customers for a particular rewards program invitation. For another example, the curator may specify one or more metadata tags—in accordance with typical digital asset management “tagging” techniques—that, where found on a digital asset, increase the likelihood of display to a user in content segment 610. In an embodiment, the curator may specify all digital assets having any of the associated metadata tags in connection with the content segment 610: “sports”, “baseball”, “basketball”, “football”, “swimming”, and the like.

One of ordinary skill will immediately appreciate from the description above that many types and combinations of relationships between content segments and digital assets may be established to form the taxonomic framework within the ambit of the present invention. One of ordinary skill will also appreciate that the digital assets may be related in such a way as to be made available for use across multiple content segments without departing from the spirit of the present invention.

Referring to step 704, the content segment framework application 602 may access and analyze user financial transaction records against the definitions of the content segments 604, 606, 608, 610. For example, the content segment framework application 602 may maintain a user list in a secure database (e.g., on memory element 58) populated with users that have consented to uses of financial transaction records such as those outlined herein. The content segment framework application 602 may instruct the DAMA application 612 to periodically query the financial transaction records maintained by the financial records server application 614 to obtain updated financial transaction records. The data fields of the financial transaction records—again, identified to specific users by primary account number or other data fields—may be evaluated periodically against the definitions of the content segments 604, 606, 608, 610. The content segment framework application 602 may also maintain data fields in the user list of the secure database reflecting the content segments most recently identified with each user according to the periodic evaluations outlined above. The user list in the secure database may be consulted by the DAMA application 612, together with the taxonomic framework established under step 703, for expedited retrieval of relevant digital assets from the content servers 616, 618, 620, 622 during a user session on one of websites 626, 628, 630, as discussed in more detail below.

For another example, the content segment framework application 602 may perform the above-referenced evaluation of financial transaction records against definitions for content segments 604, 606, 608, 610 upon demand. That is, each time a user logs into a user account, for example, via a website 626, 628, 630, the content segment framework application 602 may receive a corresponding unique user identification (e.g., primary account number, user account number, etc.), may request the DAMA application 612 to retrieve financial transaction records for the authenticated user from the financial records server application 614, and may match the user against definitions for the content segments 604, 606, 608, 610 “on the fly.” The DAMA application 612 may receive the results of the matching process and, with reference to the taxonomic framework developed under step 703, retrieve relevant digital assets from the content servers 616, 618, 620, 622.

One of ordinary skill will appreciate that evaluation of the definitions of content segments, retrieval of financial records, and/or retrieval of digital assets may be performed in a number of permutations and/or according to various schedules—for example to optimize processor loads and host server latency—within the ambit of the present invention.

Referring to step 705, a user may complete an authenticated user session (e.g., via a device 634, 636) in which the DAMA application 612 serves the user at least one digital asset based on the user's classification within one or more of the content segment(s) 604, 606, 608, 610. For example, a user electronic device 634, 636 may execute a browser to request one of the web sites 626, 628, 630 and connect to a front-end server of the content management computing device 18 via the communication network 12. The user may complete an authentication process including entry of login credentials and/or use of other known authentication steps (e.g., including biometric, token, certificate, etc. technologies) to undertake an authenticated session. The DAMA application 612 may identify one or more of the content segments 604, 606, 608, 610 in which the user falls. The DAMA application 612 may use the search appliance application 624 to query one or more of the content servers 616, 618, 620, 622 according to the taxonomic framework outlined above to identify and serve at least one digital asset to the user at the user device. It is foreseen that a number of technologies, load and/or file retrieval sequences may be utilized in conjunction with step 705 without departing from the spirit of the present invention.

Referring to step 706, the content segment framework application 602 may receive user input from the authenticated user session, automatically analyze the user input, and adjust the definitions for one or more of the content segments 604, 606, 608, 610 and/or taxonomic framework based on the analysis. For example, it is foreseen that the pre-defined rules and definitions outlined above in connection with the content segment and/or taxonomic frameworks may be automatically adjusted by employing machine learning techniques. A machine learning program may include curve fitting, regression model builders, convolutional or deep learning neural networks, Bayesian machine learning techniques, or the like. The machine learning program may be fed feedback data and underlying financial record data fields and pre-defined rules of content segments 604, 606, 608, 610—as well as the relationships defined within the taxonomic framework—to determine sub-optimal targeting of digital assets to the user. For example, where data has been collected across many authenticated sessions and users, the feedback data may comprise a count of user clicks on an advertisement for a rewards program for all users included in either or both of content segments 606, 608 within a certain timeframe. The feedback data may indicate a much higher likelihood of engagement from users in content segment 606 as compared against content segment 608, suggesting that current enrollment in another rewards program increases the chance of engagement with an advertisement about a new rewards program (with reference to the exemplary definitions developed above). Such correlations may be used for automatic and/or manual adjustment of the content segment definitions and/or taxonomic framework relating the content segments 604, 606, 608, 610 to the digital assets. For another example, metadata tags may be developed through machine learning algorithms employing text analysis and/or image recognition modules, and one or more parameters of such algorithm(s) may be adjusted based on feedback data such as number of clicks from users in particular content segments.

Therefore, in an embodiment of the present invention, financial records may—preferably with user consent—be utilized to target relevant digital assets to website user(s).

### Additional Considerations

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

We claim:

1. A computer-implemented method for serving digital assets curated according to financial transaction records, comprising:
receiving a unique user identification corresponding to a user;
retrieving a plurality of financial transaction records associated with the user;
evaluating the plurality of financial transaction records against criteria for a plurality of content segments;
classifying the user in at least one of the plurality of content segments based at least in part on the evaluation of the plurality of financial transaction records; and
serving at least one digital asset to the user at a user device based on the classification.

2. The computer-implemented method of claim 1, wherein the criteria comprise at least one pre-defined rule governing each of the plurality of content segments.

3. The computer-implemented method of claim 2 wherein the plurality of financial transaction records comprise structured data and each pre-defined rule defines at least one structured data field.

4. The computer-implemented method of claim 3, wherein the at least one structured data field of each pre-defined rule contains data exchanged in accordance with a standardized interchange format by processing entities in connection with a plurality of transactions corresponding to the plurality of financial transaction records.

5. The computer-implemented method of claim 4, wherein the at least one structured data field of each pre-defined rule corresponds to at least one of: primary account number; transaction type; amount transaction; transmission date and time; retrieval reference number; response code; card acceptor name/location; personal identification number; and merchant type.

6. The computer-implemented method of claim 4, wherein each of the plurality of transaction records includes a threshold consent data field.

7. The computer-implemented method of claim of claim 5, wherein at least one of the pre-defined rules includes a summation of a number of transactions within a given time period including a specified value for the merchant type data field.

8. The computer-implemented method of claim 5, wherein at least one of the pre-defined rules includes a summation of an amount transaction total within a given period of time.

9. The computer-implemented method of claim 3, wherein each pre-defined rule defines at least one unstructured data element.

10. The computer-implemented method of claim 9, wherein at least one of the pre-defined rules specifies a data element corresponding to user enrollment in a rewards program.

11. The computer-implemented method of claim 1, further comprising retrieving the plurality of financial transaction records from a server using a secure transmission protocol.

12. The computer-implemented method of claim 11, wherein the plurality of financial transaction records is transmitted via authentication by Mutual Secure Sockets Layer protocols.

13. The computer-implemented method of claim 1, further comprising implementing a taxonomic framework relating the plurality of content segments to a plurality of digital assets stored at a plurality of content servers, wherein the taxonomic framework is used to identify the at least one digital asset served to the user.

14. The computer-implemented method of claim 13, wherein—
a merchant type data field is included in a first pre-defined rule corresponding to a first content segment of the plurality of content segments, the first pre-defined rule specifying a minimum number of occurrences of a value in the merchant type data field within a given time period,
the taxonomic framework includes a relationship between the first content segment and digital assets of the plurality of digital assets associated with at least one specified metadata tag.

15. The computer-implemented method of claim 13, wherein—
an amount transaction data field is included in a first pre-defined rule corresponding to a first content segment of the plurality of content segments, the first pre-defined rule specifying a minimum total value summed from the amount transaction data field within a given time period,
the taxonomic framework includes a relationship between the first content segment and digital assets of the plurality of digital assets associated with at least one specified metadata tag.

16. The computer-implemented method of claim 13, wherein the plurality of financial transaction records is retrieved according to a pre-determined schedule, and the taxonomic framework is implemented to identify the at least one digital asset in response to receipt of the unique user identification.

17. The computer-implemented method of claim 13, wherein each of a plurality of users is classified according to the criteria of the plurality of content segments and is served at least one of the plurality of digital assets through implementation of the taxonomic framework, further comprising—
receiving a data set reflecting a plurality of user inputs from the plurality of users in response to service of the plurality of digital assets,
automatically analyzing the data set to identify at least one correlation between the data set and the criteria of the plurality of content segments,
automatically adjusting the criteria at least in part based on the at least one correlation.

18. The computer-implemented method of claim 13, wherein each of a plurality of users is classified according to the criteria of the plurality of content segments and is served at least one of the plurality of digital assets through implementation of the taxonomic framework, further comprising—
receiving a data set reflecting a plurality of user inputs from the plurality of users in response to service of the plurality of digital assets,
automatically analyzing the data set to identify at least one correlation between the data set and the taxonomic framework,
automatically adjusting the taxonomic framework at least in part based on the at least one correlation.

19. The computer-implemented method of claim 17, wherein a computer learning algorithm analyzes the data set and automatically adjusts the criteria.

20. The computer-implemented method of claim 1, wherein the plurality of financial transaction records is retrieved in response to receipt of the unique user identification.
